(19) United States
(12) Patent Application Publication
(10) Pub. No.: US 2006/0281823 A1
(43) Pub. Date: Dec. 14, 2006

(54) Foamable water-in-oil type emulsion composition

(75) Inventors: Masanobu Uchikoshi, Tokyo (JP); Takeshi Yasumasu, Tokyo (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: KAO CORPORATION, TOKYO (JP)

(21) Appl. No.: 10/547,777

(22) PCT Filed: Mar. 8, 2004
(86) PCT No.: PCT/JP04/02977

§ 371 Date: Sep. 6, 2005

(30) Foreign Application Priority Data
Mar. 7, 2003 (JP) 2003-061309
Mar. 11, 2003 (JP) 2003-064588
Mar. 11, 2003 (JP) 2003-064697

(51) Int. Cl. B01F 3/08; B01F 17/00; C09K 3/00

(52) U.S. Cl. 516/21; 516/10

(57) ABSTRACT

The present invention provides a foamable water-in-oil emulsion composition containing diglyceride-containing fats and oils and a liquid sugar, wherein (a) said fats and oils have a solid fat content ranging from 0.5 to 5 wt % thereof; (b) said fats and oils contain 40 wt % or more of an unsaturated diglyceride having a carbon number ranging from 16 to 18; and (c) the weight ratio of said fats and oils vs. said liquid sugar ranges from 1:0.5 to 1:4. The resultant emulsion has improved in-mouth meltability, good shape retention at room temperatures and a good eating texture with a reduced specific gravity.

### FIELD OF THE INVENTION

The present invention relates to a foamable water-in-oil type emulsion composition for use in buttercreams or like products and to a method of producing the same.

### BACKGROUND OF THE INVENTION

Foamable water-in-oil type emulsion compositions, having external phases of fats and oils, are known to characteristically have a high resistance to proliferation of microorganisms, an excellent shape retention, a good keeping quality and are widely used for foods or food materials, including creams, spreads, sandwiches, cookings, confectionery, breads, and so on (cf. JP-A-1977-126406, JP-A-1986-085141). However, since these emulsion compositions comprise external phases of fats and oils, they inevitably involve inferior in-mouth meltability or like shortcomings, and for such shortcomings to be eliminated, fats and oils constituting the external phases must be replaced with softer types at the sacrifice of their shape retention, thus rendering them more liable to develop oil-off or like oil separation.

As a means to ameliorate such shortcomings, it has been known to add a specific emulsifier (JP-A-2001-178361), or mix a diglyceride having an increased melting point lower than 200° C. in a quantity of 10 to 99% by weight in the total fats and oils (JP-B-1995-38780), or the like. However, such known means have failed to provide a water-in-oil emulsion composition which exhibits good shape retention and in-mouth meltability at room temperatures (about 25° C.) and has a soft feel.

### SUMMARY OF THE INVENTION

In its first aspect, the present invention provides an foamable water-in-oil type emulsion composition containing a diglyceride-containing fats and oils and a liquid sugar, wherein (a) the fats and oils has a solid fat content ranging from 0.5 to 5% thereof at 25° C.; (b) the fats and oils contains 40 wt % or more of an unsaturated diglyceride having a carbon number ranging from 16 to 18; and (c) the weight ratio of the fats and oils vs. the liquid sugar ranges from 1:0.5 to 1:4.

In its second aspect, the present invention provides an foamable water-in-oil type emulsion composition containing the following ingredients (A) through (D): (A) fats and oils having a solid fat content (SFC) ranging from 5 to 10% at 25° C. and an unsaturated fatty acid content ranging from 40 to 90 wt %

10 to 70 wt %;

(B) a saccharide 10 to 60 wt %;

(C) gluten 0.4 to 5.0 wt %;

(D) gelatin 0.05 to 1.0 wt %.

In its third aspect, the present invention provides a method of producing an foamable water-in-oil type emulsion composition, including whipping an aqueous phase containing a saccharide and protein and then adding under agitation thereto fluid fats and oils having an 15% or lower solid fat content (SFC) at 250° C.

### MODES FOR CARRYING OUT THE INVENTION

Initially, the present invention as its first aspect will be described.

The inventors have found out that a water-in-oil emulsion composition having dramatically improved in-mouth meltability and thermostability with a low specific gravity and a good eating texture (in the first aspect of the present invention) can be produced by using high diglyceride-content fats and oils as base fats and oils for forming an emulsion, if the fats and oils has a specific fatty acids composition, a solid fat content ranges from 0.5 to 5% thereof at 25° C., and the ratio of the fats and oils vs. liquid sugar contents in the emulsion is kept in a predetermined range.

The foamable water-in-oil type emulsion composition provided by the present invention in the first aspect thereof has improved in-mouth meltability, good shape retention at room temperatures and a good eating texture with a reduced specific gravity, so that the present emulsion composition may be useful as a buttercream for use in the preparation or production of creams, spreads, sandwiches, confectionery, breads, and so on.

The foamable water-in-oil type emulsion composition provided by the present invention in its first aspect contains diglyceride-containing fats and oils and a liquid sugar. The solid fat content of the fats and oils at 25° C. indicated as (a) herein above refers to a solid fat content (SFC) in the fats and oils at 25° C. and ranges preferably from 0.5 to 5% and more preferably from 1.0 to 5.0% in view of eating texture such as in-mouth meltability or smooth texture, and thermostable shape retention at 25° C. The SFC (solid fat content) of the fats and oils at 25° C. herein was measured in accordance with the Tentative 1-1996 NMR Method for Solid Fat Content (given in “Standard Fats and Oils Analysis and Test Methods” edited by Japan Oil Chemical Society). The solid fat content is given in % by weight.

In the first aspect of the present invention, the content in the fats and oils of the unsaturated diglyceride having a carbon number of 16 to 18 indicated as (b) above is preferably 40 wt %, or more and ranges more preferably from 40 to 90 wt % and further preferably from 40 to 80 wt % from a viewpoint of improvement in eating texture such as foamability or in-mouth meltability. The unsaturated diglyceride having a carbon number ranging from 16 to 18 herein referred to include, but not limited to, fats and oils derived from olive oil, soybean oil, rapeseed oil, castor oil, corn oil, cottonseed oil, peanut oil, safflower oil, sesame oil, or any mixtures, interesterified derivatives, and fatty acids interchange derivatives thereof.

Also, the diglyceride-containing fats and oils has a purity of diglyceride ranging preferably from 78 to 99 wt %, more preferably from 78 to 90 wt % and further preferably from 78 to 85 wt % from a viewpoint of improvement in eating texture involving in-mouth meltability. Further, the content in the fats and oils of diglycerides other than the unsaturated diglyceride having a carbon number of 16 to 8 ranges preferably from 0.5 to 6.0 wt % and more preferably from 0.5 to 5.0 wt % in view of in-mouth meltability.

The diglycerides used for the present invention may be obtained, for example, by: interesterifying a mixture of one or more fats and oils selected from edible fats and oils and glycerin; esterifying edible fats and oils-derived fatty acid composition with glycerin; and reacting a fatty acid with glycerin using lipase. If necessary, any excess monoglyceride formed in glycerides mixtures produced in these processes may be removed by molecular distillation or chromatography. The edible fats and oils used herein include, for example, but not limited to: vegetable fats and oils such as palm oil, rapeseed oil, soybean oil, corn oil, cottonseed oil, safflower oil, olive oil, coconut oil, or palm kernel oil; animal fats and oils such as milk fat, lard, tallow, fish oil; hydrogenated oils of these plant and animal fats and oils; interesterified oils thereof; and mixtures of two or more of these fats and oils.

As the fats and oils used for the emulsion compositions of the present invention, triglycerides or monoglycerides may also be used in addition to the foregoing diglycerides. The monoglyceride content in the fats and oils may range preferably from 0 to 5 wt %, more preferably from 0 to 3 wt % and further preferably from 0 to 2 wt % in view of in-mouth meltability.

The triglyceride content may range from 0 to 70wt %, more preferably from 10 to 60 wt % and further preferably from 20 to 60 wt %. As the triglycerides herein referred to, the above described edible fats and oils may be used, including, for example, but not limited to: vegetable fats and oils such as palm oil, rapeseed oil, soybean oil, corn oil, cottonseed oil, safflower oil, olive oil, coconut oil, or palm kernel oil; animal fats and oils such as milk fat, lard, tallow, fish oil; hydrogenated oils of these plant and animal fats and oils; interesterified oils thereof; and mixtures of two or more of these fats and oils.

Further, the ratio of fats and oils versus liquid sugar indicated above as (c) in the emulsion compositions of the present invention may range preferably from 1:0.5 to 1:4, more preferably from 1:1 to 1:4, further preferably from 1:1 to 1:4 and furthermore preferably from 1:1 to 1:3 in view of stability during mixing. As the liquid sugar herein referred to, any saccharides commercially available in a liquid state may be used or any powdered sugars may be used after solution state. Specifically, for this purpose, any monosaccharides, disaccharides, trisaccharides, tetrasaccharides, pentasaccharides, hexasaccharides, starch hydrolysates, sugar alcohols reduced from these saccharides, mixtures of these saccharides or their derivatives, or starch syrups may be used, including glucose, maltose, sucrose, lactose, trehalose, maltotriose, tetraose, sorbitol, xylitol, erythritol, multitol, and so on. Among these, it is more preferable to use monosaccharides, disaccharides, trisaccharides, or sugar alcohols reduced therefrom in view of sweetness.

For saccharides, it is preferable to use such a liquid sugar that has a sugar content as solid ranging from 40 to 80 wt %, more preferably from 50 to 80 wt % and further preferably from 60 to 75 wt % in view of keeping quality and sweetness.

In addition to the aforementioned fats and oils and saccharides, the emulsion composition of the present invention may contain dairy products including, for example, whole milk powder, buttermilk, skimmed milk powder, sweetened whole condensed milk, sweetened condensed skim milk, fresh cream, or proteins such as sodium caseinate (casein Na), whey and so on; thickeners such as xanthan gum, Cyamoposis Gum, gum arabic, CMC (carboxymethyl cellulose), Locust bean gum, pectin, carrageenan, and so on; emulsifiers such as monoglycerides, organic acid-derived monoglycerides, sucrose fatty acid esters, polyglyceryl fatty acid esters, lecithin, enzyme-treated lecithin, propylene glycol fatty acid esters, and so on, to which milk flavor, vanilla flavor, vanilla essence and like flavors or essences may be added as required.

The emulsion composition of the present invention may be produced by any methods capable of forming a foamable water-in-oil type emulsion composition, it may preferably produced, for example, by first whipping the fats and oils and then adding under agitation thereto one or more flavoring agents such as liquid sugar, jam, chocolate, sweetened condensed milk, etc.

The resultant foamable water-in-oil type emulsion composition of the present invention in its first aspect preferably has a specific gravity ranging from 0.30 to 0.70 and particularly from 0.40 to 0.60 from a viewpoint of eating texture, in-mouth meltability and smooth texture.

In the next place, the present invention as its second aspect will be described.

The inventors have found out that a water-in-oil emulsion composition having dramatically improved in-mouth meltability and thermostability with a low specific gravity and a good eating texture (in the second aspect of the present invention) can be produced by using, as a base fat an oil for forming an emulsion, fats and oils having a solid fat content (SFC) ranging from 5 to 10% at 25° C. and an unsaturated fatty acid content ranging from 40 to 90 wt %, and a certain amount of gluten and gelatin.

The foamable water-in-oil type emulsion composition provided by the present invention in the second aspect thereof has improved in-mouth meltability and excellent thermostability with a reduced specific gravity, so that the present emulsion composition may be useful as a buttercream for use in the preparation or production of creams, spreads, sandwiches, confectionery, breads, and so on.

The ingredient (A) contained in the foamable water-in-oil type emulsion composition of the present invention in its second aspect, namely, the fats and oils having a solid fat content (SFC) ranging from 5 to 10% at 25° C. and an unsaturated fatty acid content ranging from 40 to 90 wt % may include any of triglycerides, diglycerides, monoglycerides, or mixtures thereof. As the triglycerides referred to here, any edible fats and oils may be used, including, for example, but not limited to: vegetable fats and oils such as palm oil, rapeseed oil, soybean oil, corn oil, cottonseed oil, safflower oil, olive oil, coconut oil, or palm kernel oil; animal fats and oils such as milk fat, lard, tallow, fish oil; hydrogenated oils of these plant and animal fats and oils; interesterified oils thereof; and mixtures of two or more of these fats and oils. The diglycerides referred to here may be obtained by interesterifying a mixture of one or more fats and oils selected from the above-named edible fats and oils and glycerin, esterifying edible fats and oils-derived fatty acid composition with glycerin, or reacting a fatty acid with glycerin using lipase, and then removing excess monoglyceride formed in the resultant glycerides mixtures by molecular distillation or chromatography.

Such fats and oils (A) as above may have an SFC ranging preferably from 5 to 10% and more preferably from 5 to 9% at 25° C. in view of eating texture such as in-mouth meltability or smooth velvety and thermostable shape retention at 25° C. Here, the SFC (solid fat content) at 25° C. may be measured in the same manner as in the first aspect of the present invention.

The fats and oils (A) may have a unsaturated fatty acid content ranging preferably from 40 to 90 wt %, more preferably from 60 to 90 wt % and further preferably from 70 to 90 wt % of the total fatty acid. Also, their constituent fatty acids may have a carbon number of preferably from 14 to 22, more preferably from 16 to 20 and further preferably from 16 to 18.

The fats and oils (A) may have a ratio of triglyceride-versus-diglyceride (by weight) ranging preferably from 100:0 to 10:90, more preferably from 100:0 to 20:80 and further preferably from 100:0 to 30:70. The monoglyceride content in the fats and oils may range preferably from 0 to 5 wt %, more preferably from 0 to 3 wt % and further preferably from 0 to 2 wt % from a viewpoint of flavor.

The triglyceride contained in the fats and oils (A) may have a carbon number of its constituent fatty acids ranging preferably from 14 to 22, more preferably from 16 to 20 and further preferably from 16 to 18. Also, the triglyceride may have a unsaturated fatty acid content ranging preferably from 40 to 90 wt %, more preferably from 60 to 90 wt % and further preferably from 70 to 90 wt % in view of in-mouth meltability and thermostable shape retention at 25° C. The fats and oils may have a triglyceride content ranging preferably from 20 to 100 wt %, more preferably from 25 to 100 wt % and further preferably from 30 to 99 wt % in view of in-mouth meltability and thermostable shape retention at 25° C.

The diglyceride contained in the fats and oils (A) may have a carbon number of its constituent fatty acids ranging preferably from 14 to 22, more preferably from 16 to 20 and further preferably from 16 to 18. Also, the diglyceride may have a unsaturated fatty acid content ranging preferably from 40 to 90 wt %, more preferably from 60 to 90 wt % and further preferably from 70 to 90 wt % in view of in-mouth meltability and thermostable shape retention at 25° C. The fats and oils may have a diglyceride content ranging preferably from 1 to 80 wt %, more preferably from 1 to 75 wt % and further preferably from 1 to 70 wt % in view of in-mouth meltability and thermostable shape retention at 25° C.

Here, any unsaturated fatty acid-derived triglycerides or unsaturated fatty acid-derived diglycerides may be used, including, but not limited to, fats and oils derived from olive oil, soybean oil, rapeseed oil, castor oil, corn oil, cottonseed oil, peanut oil, safflower oil, sesame oil, or any mixtures, interesterified derivatives, and fatty acids interchange derivatives thereof. As fats and oils other than unsaturated fatty acid-derived triglycerides or unsaturated fatty acid-derived diglycerides, the fats and oils (A) may also contain saturated triglycerides, saturated diglycerides or their mixtures.

The above-described fats and oils (A) may be contained in the foamable water-in-oil type emulsion composition of the present invention in its second aspect in a quantity ranging preferably from 10 to 70 wt %, more preferably from 10 to 60 wt % and further preferably from 20 to 60 wt % from a view point of thermostable shape retention at 25° C.

The above-described saccharides (B) usable for the present invention may be either in the form of liquid sugar or powder sugar and include any monosaccharides, disaccharides, trisaccharides, tetrasaccharides, pentasaccharides, hexasaccharides, starch hydrolysates, sugar alcohols reduced from these saccharides, mixtures of these saccharides or their derivatives, or starch syrups, including glucose, maltose, sucrose, lactose, trehalose, maltotriose, tetraose, sorbitol, xylitol, erythritol, multitol, and so on. Among these, it is more preferable to use monosaccharides, disaccharides, trisaccharides, or sugar alcohols reduced therefrom from a viewpoint of sweetness.

The saccharides (B) may be contained in the foamable water-in-oil type emulsion composition of the present invention in its second aspect in a quantity as solid ranging preferably from 10 to 60 wt %, more preferably from 15 to 60 wt % and further preferably from 20 to 55 wt % from a view point of keeping quality and sweetness. The saccharides (B) may be contained in an aqueous phase used in a quantity as solid ranging preferably from 40 to 75 wt %, more preferably from 45 to 70 wt % and further preferably from 50 to 70 wt % from a view point of keeping quality.

As the gluten (C) used for the present invention, wheat gluten or decomposed products through acid decomposition or enzyme decomposition of wheat gluten may be used. The gluten (C) may be contained in the foamable water-in-oil type emulsion composition of the present invention in its second aspect in a quantity ranging preferably from 0.4 to 5.0 wt %, more preferably from 0.5 to 4.0 wt % and further preferably from 0.5 to 3.0 wt % in view of improvement in foamability.

The gelatin (D) used for the present invention includes those derived from cattle bones, cowskins or pigskins. The gelatin (D) may be contained in the foamable water-in-oil type emulsion composition of the present invention in a quantity ranging preferably from 0.05 to 1.0 wt %, more preferably from 0.07 to 0.7 wt % and further preferably from 0.1 to 0.5 wt % in view of shape retention.

Also, the ratio by weight of gluten (C) and gelatin (D) ranges preferably from 1:1 to 50:1, more preferably from 2:1 to 20:1 and further preferably from 3:1 to 10:1 in view of foamability and stability as syrup fluid.

Further, the ratio by weight of fats and oils versus aqueous phase in the emulsion compositions of the present invention in its second aspect may range preferably from 1:0.3 to 1:4, more preferably from 1:0.5 to 1:3 and further preferably from 1:0.5 to 1:2 in view of stability during mixing.

In addition to the aforementioned ingredients, the foamable water-in-oil type emulsion composition of the present invention may contain dairy products including, for example, whole milk powder, buttermilk, skimmed milk powder, sweetened whole condensed milk, sweetened condensed skim milk, fresh cream, or proteins such as sodium caseinate, whey and so on; thickeners such as xanthan gum, Cyamoposis Gum, gum arabic, CMC (carboxymethyl cellulose), Locust bean gum, pectin, carrageenan, and so on; emulsifiers such as organic acid-derived monoglycerides, sucrose fatty acid esters, polyglyceryl fatty acid esters, lecithin, enzyme-treated lecithin, propylene glycol fatty acid esters, and so on, to which milk flavor, vanilla flavor, vanilla essence and like flavors or essences may be added as required.

The emulsion composition of the present invention in its second aspect may be produced by any methods capable of forming a foamable water-in-oil type emulsion composition, it may preferably be produced, for example, by first whipping the fats and oils and then adding thereto saccharides, gluten, or gelatin, etc. to prepare a syrup-like-mixture therefrom and then mixing the same under agitation.

The foamable water-in-oil type emulsion composition of the present invention in its second aspect preferably has a specific gravity ranging from 0.15 to 0.70 and more preferably from 0.20 to 0.60 from a viewpoint of eating texture, in-mouth meltability and thermostable shape retention.

Now, the present invention as its third aspect will be described. The inventors have found out that a foamable water-in-oil type emulsion composition having a good in-mouth meltability and cream lightness with specific gravity as low as 0.20 to 0.60 and also showing a good emulsification stability even at 25° C. can be produced by first whipping an aqueous phase containing a saccharide and protein and then adding under agitation thereto fats and oils having a specific SFC to form an water-in-oil emulsified system.

Thus, according to the method of the present invention in its third aspect, it is possible to obtain a foamable water-in-oil type emulsion composition having a reduced specific gravity and improved in-mouth meltability, cream lightness, sweetness with excellent shape retention at room temperatures and good eating texture, which is useful as a buttercream for confectionery and breadmaking.

The third aspect of the present invention is characterized in that the aqueous phase containing a saccharide and protein is first whipped, not the fats and oils. Here, the saccharides usable for the present invention may be in the form of either liquid sugar or powder sugar and include any monosaccharides, disaccharides, trisaccharides, tetrasaccharides, pentasaccharides, hexasaccharides, starch hydrolysates, sugar alcohols reduced from these saccharides, mixtures of these saccharides or their derivatives, or starch syrups, including glucose, maltose, sucrose, lactose, trehalose, maltotriose, tetraose, sorbitol, xylitol, erythritol, multitol, and so on. Among these, it is more preferable to use monosaccharides, disaccharides, or sugar alcohols reduced therefrom in view of viscosity of the sugar solution and sweetness.

The saccharides may be contained in the foamable water-in-oil type emulsion composition in a quantity ranging preferably from 20 to 60 wt %, more preferably from 30 to 56 wt % and further preferably from 35 to 55 wt % from a viewpoint of keeping quality and sweetness. Also, the saccharides may be contained in the aqueous phase in a quantity as solid ranging preferably from 40 to 75 wt %, more preferably from 45 to 70 wt % and further preferably from 50 to 70 wt % from a view point of keeping quality.

As the proteins, it is preferred to use gluten and gelatin in combination from a viewpoint of improvement in foamability and thermostable shape retention. The glutens usable for the present invention may include, but not limited to, wheat glutens, decomposed products of glutens, or the like obtained through acid decomposition or enzyme decomposition. As the gelatins, any gelatins derived from cattle bone, cowskin or pigskin may be used.

For the gluten and gelatin, these ingredients may be contained in the aqueous phase in a quantity as their total content ranging preferably from 0.5 to 6.0 wt %, more preferably from 1.0 to 4.0 wt % and further preferably from 1.5 to 3.0 wt % in view of improvement in foamability and thermostable shape retention. Also, the ratio by weight of the gluten and the gelatin ranges preferably from 1:1 to 50:1, more preferably from 2:1 to 20:1 and further preferably from 3:1 to 10:1 in view of foamability and stability as syrup fluid.

Further, the gluten may be contained in the aqueous phase in a quantity ranging preferably from 0.5 to 5.0 wt %, more preferably from 0.6 to 4.0 wt % and further preferably from 0.7 to 3.0 wt % in view of foamability. Besides, the gelatin may be contained in the aqueous phase in a quantity ranging preferably from 0.05 to 1.0 wt %, more preferably from 0.07 to 0.7 wt % and further preferably from 0.1 to 0.5 wt % in view of shape retention.

For the proteins, whole milk powder, buttermilk, skimmed milk powder, sweetened whole condensed milk, sweetened condensed skim milk, fresh cream, or proteins such as sodium caseinate, whey or like proteins may also be used in addition to gluten and gelatin above. Additionally, the emulsion composition of the present invention may be mixed with emulsifiers such as monoglycerides, organic acid-derived monoglycerides, sucrose fatty acid esters, polyglyceryl fatty acid esters, lecithin, enzyme-treated lecithin, propylene glycol fatty acid esters, etc., and further milk flavor, vanilla flavor, vanilla essence and like flavors or essences may be added thereto as required.

In addition to the above saccharides and proteins, the aqueous phase may contain polysaccharide thickeners such as xanthan gum, Cyamoposis Gum, gum arabic, CMC, Locust bean gum, pectin, carrageenan, etc.; or tapioca, corn starch, waxy corn starch, modified or pregelatinized products of these starches.

Although the aqueous phase may be whipped, for example, by means of a vertical mixer such as Hobart Mixer or Kanto Mixer, it is preferred to use such a vertical mixer in combination with a wire whisk or a beater. The wire whisk is more preferred. In this regard, it is preferable to continue the whipping until the aqueous phase reaches 0.15 to 0.30 and more preferably 0.15 to 0.25 in specific gravity.

Then, fats and oils is added to the foamed aqueous phase material under agitation. As the fats and oils here, it is preferable to use fluid fats and oils having an SFC at 25° C. of 15% or below, more preferably from 3 to 15% and further preferably from 3 to 10% in order to prevent phase inversion from water-in-oil type to oil-in-water type and to obtain a foamable water-in-oil type emulsion composition having a good emulsification stability and a lower specific gravity. Although the oil phase may be whipped, for example, by means of a vertical mixer such as Hobart Mixer or Kanto Mixer, it is preferred to use such a vertical mixer in combination with a wire whisk or a beater. The beater is more preferred. Also, it is preferable to continue the whipping until the oil phase reaches 0.20 to 0.50 and more preferably 0.20 to 0.45 in-specific gravity.

Here, the same requirement of SFC at 25° C. as in the first aspect of the present invention applies.

As the fats and oils here, any triglycerides, diglycerides, monoglycerides or mixtures of these glycerides may be used. As the triglycerides herein referred to, any edible fats and oils may be used, including, for example, but not limited to: vegetable fats and oils such as palm oil, rapeseed oil, soybean oil, corn oil, cottonseed oil, safflower oil, olive oil, coconut oil, or palm kernel oil; animal fats and oils such as milk fat, lard, tallow, fish oil; hydrogenated oils of these plant and animal fats and oils; interesterified oils thereof; and mixtures of two or more of these fats and oils. The diglycerides referred to here may be obtained by interesterifying a mixture of one or more fats and oils selected from the above-named edible fats and oils and glycerin, esterifying edible fats and oils-derived fatty acid composition with glycerin, or reacting a fatty acid with glycerin using lipase, and then removing excess monoglyceride formed in the resultant glycerides mixtures by molecular distillation or chromatography.

As the fats and oils used for the present invention, any fats and oils containing 40 to 90 wt % of an unsaturated triglyceride having a carbon number ranging from 14 to 18 or an unsaturated diglyceride having a carbon number ranging from 14 to 18 may preferably be used, among which fats and oils containing 40 to 90 wt % of an unsaturated diglyceride having a carbon number ranging from 14 to 18 latter content is more preferable and fats and oils containing 40 to 90 wt % of an unsaturated diglyceride having a carbon number ranging from 16 to 18 latter content is further preferable. Here, any unsaturated triglycerides or unsaturated diglycerides may be used, including, but not limited to, fats and oils derived from olive oil, soybean oil, rapeseed oil, castor oil, corn oil, cottonseed oil, peanut oil, safflower oil, sesame oil, or mixtures of these oils. As fats and oils other than unsaturated triglycerides or unsaturated diglycerides, the fats and oils may also contain saturated triglycerides, saturated diglycerides or their mixtures.

The fats and oils may be contained in the foamable water-in-oil type emulsion composition in a quantity ranging preferably from 20 to 50 wt %, more preferably from 20 to 40 wt % and further preferably from 20 to 35 wt % from a viewpoint of improvement in eating texture such as in-mouth meltability or smooth texture and thermostable shape retention at 25° C.

In the present method, the ratio by weight of the fats and oils and aqueous phase ranges preferably from 1:1 to 1:4 and more preferably from 1:1 to 1:3 in view of stability during mixing.

Preferably, the fats and oils is mixed under agitation with the aqueous phase slowly or fraction by fraction. The whipping, addition of the fats and oils and agitation may be carried out preferably at 20 to 25° C.

The foamable water-in-oil type emulsion composition of the present invention has a specific gravity ranging from 0.20 to 0.60 and more preferably from 0.20 to 0.55.

### EXAMPLES

### Preferred Examples 1, 2 and Comparative Examples 1 Through 5

For preparation, fats and oils melted at 60° C. were cooled down to 15° C. in a chiller (emulsifying kneader made by Tama Seiki Kogyo Co., Ltd., Tokyo) and then maintained at 20° C. (for tempering) for 1 day followed by storage in a refrigerator (5° C.).

Each fats and oils formulation of 100 parts by weight shown in Table 1 was whipped and mixed under agitation with 180 parts by weight of liquid sugar containing 70 wt % of sugar and 20 parts by weight of condensed milk to produce a foamable water-in-oil type emulsion composition.

### Preferred Examples 3, 4 and Comparative Examples 6

For preparation, fats and oils melted at 60° C. were cooled down to 15° C. in a chiller (emulsifying kneader made by Tama Seiki Kogyo Co., Ltd., Tokyo) and then maintained at 20° C. (for tempering) for 1 day followed by storage in a refrigerator (5° C.).

Each fats and oils formulation of 100 parts by weight shown in Table 1 was whipped and mixed under agitation with 90 parts by weight of liquid sugar (produced by NIHON SHOKUHIN KAKO CO., LTD., Tokyo) containing 70 wt % of sugar and 10 parts by weight of condensed milk (produced by Snow Brand Milk Products Co. Ltd., Tokyo) to produce a foamable water-in-oil type emulsion composition.

Here, the solid fat content (SFC) of the fats and oils at 25° C. used was measured in accordance with the Tentative 1-1996 NMR Method for Solid Fat Content (given in “Standard Fats and Oils Analysis and Test Methods” edited by Japan Oil Chemical Society). Specifically, the solid fat content was determined in the following manner:

1) After keeping each test sample and control sample in a test tube at 60.0±0.2° C. for 30 min., NMR signal is read for each sample.

2) These samples are maintained at 0±2° C. for 30 min. and then moved to a 26.0±0.2° C. environment and maintained there for further 30 min.

3) After returning to 0±20° C. environment again and maintaining there for 30 min., the samples are maintained at a predetermined test temperature (25±0.2° C.) for further 30 min. and then NMR signal is read for each sample.

4) The solid fat content at 25° C. is determined using the following formula:

Solid fat content (%)=100−(A/B)×(C/D)×100

A: NMR signal reading for control sample at 60° C.

B: NMR signal reading for test sample at 60° C.

C: NMR signal reading for control sample at 25° C.

D: NMR signal reading for test sample at 25° C.

TABLE 1
(wt %)

| | Preferred | Preferred | Preferred | Preferred | Comparative | Comparative | Comparative | Comparative | Comparative | Comparative |
|---|---|---|---|---|---|---|---|---|---|---|
| Fats and oils | example 1 | example 2 | example 3 | example 4 | example 1*² | example 2*² | example 3 | example 4 | example 5 | example 6 |
| Hydrogenated | 20.0 | 20.0 | 20.0 | 20.0 | | 20.0 | 50.0 | | | 50.0 |
| rapeseed oil | | | | | | | | | | |
| (IV69) | | | | | | | | | | |
| Hydrogenated | | | | | | | | | | |
| rapeseed | | | | | | | | | | |
| oil (IV80) | | | | | | | | | | |
| Hydrogenated | | | | | | | | 100.0 | 50.0 | |
| fish oil | | | | | | | | | | |
| (MP 29° C.) | | | | | | | | | | |
| Hydrogenated | | | | | | | | | 50.0 | |
| fish oil | | | | | | | | | | |
| (MP 36° C.) | | | | | | | | | | |
| Refined | 20.0 | 0.0 | 20.0 | 20.0 | 0.0 | 80.0 | 50.0 | 0.0 | 0.0 | 50.0 |
| rapeseed oil | | | | | | | | | | |
| Unsaturated | 60.0 | 80.0 | 60.0 | 80.0 | 100.0 | 0.0 | 0.0 | 0.0 | 0.0 | 0.0 |
| diglyceride*¹ | | | | | | | | | | |
| Triglyceride | 48.6 | 31.0 | | | 14.0 | 99.6 | 99.7 | 99.0 | 99.2 | 97.7 |
| Diglyceride | 50.8 | 68.2 | | | 85.0 | 0.3 | 0.2 | 0.6 | 0.5 | 0.2 |
| Monoglyceride | 0.6 | 0.8 | | | 1.0 | 0.1 | 0.1 | 0.4 | 0.3 | 0.1 |
| 25° C. | 2.1 | 2.3 | 2.1 | 2.3 | 0.0 | 2.0 | 16.8 | 4.8 | 9.9 | 16.8 |
| SFC (%) | | | | | | | | | | |
| Unsaturated | 85.9 | 85.2 | | | 88.1 | 88.0 | 82.7 | 62.5 | 60.6 | |
| Fatty acid | | | | | | | | | | |
| content | | | | | | | | | | |
| Melting point | 26.4 | 26.7 | | | 5.2 | 26.5 | 34.8 | 29.1 | 32.7 | |
| (° C.) | | | | | | | | | | |
| Specific gravity | 0.21 | 0.20 | 0.21 | 0.20 | 0.99 | 0.97 | 0.48 | 0.32 | 0.30 | 0.48 |
| after whipping | | | | | | | | | | |
| *¹Using an immobilized 1,3-positions selective lipase (trade name: “Lipozyme 3A), 860 g of a rapeseed oil-derived fatty acid was allowed to react with 140 g of glycerin at 40° C. for 10 hours. After filtering out the lipase agent, | | | | | | | | | | |
| # the reaction product was subjected to molecular distillation and refined in the usual manner to obtain a liquid unsaturated diglyceride composition. This resultant composition contained 1.0 wt % monoglyceride, 85.0 wt % diglyceride and 14.0 wt % triglyceride. | | | | | | | | | | |

*²The comparative examples 1 and 2 did not foam.

For each resultant emulsion composition, the specific gravity was measured using a specific gravity cup.
Specific gravity (g/ml)=cream weight (g)/volume of specific gravity cup (ml)

The resultant compositions were subjected to sensory test by 20 expert panelists for evaluation of in-mouth meltability.

Further, after maintaining a filter paper coated with a predetermined quantity of each cream at 25° C. for 2 days, the cream was removed and the quantity of the residual cream impregnated in the filter paper was measured as the oil-off quantity.

For evaluation of 25° C. thermostability, samples having an oil-off smaller than 15% were rated as good (A), with 15 to 20% oil-off as average (B) and 20% or larger oil-off as bad (C).

Further, for overall evaluation, those samples having a specific gravity ranging from 0.35 to 0.70 and rated as good in both in-mouth meltability and thermostability were evaluated as good (A), while samples rated as bad in at least one of these test items were evaluated as bad (C).

The evaluation result is shown in Table 2 below.

TABLE 2

| | Preferred examples | | | | Comparative examples | | | | | |
|---|---|---|---|---|---|---|---|---|---|---|
| | 1 | 2 | 3 | 4 | 1 | 2 | 3 | 4 | 5 | 6 |
| Specific gravity | 0.51 | 0.45 | 0.41 | 0.35 | 1.01 | 0.99 | 0.75 | 0.70 | 0.75 | 0.65 |
| In-mouth | A | A | A+ | A+ | B | B | C | B | C | C |
| meltability | | | | | | | | | | |
| 25° C. oil-off | 8.8 | 9.0 | 8.5 | 8.7 | 80.0 | 62.3 | 8.6 | 24.2 | 8.1 | 17.2 |
| 25° C. | A | A | A | A | C | C | A | C | A | C |
| thermostability | | | | | | | | | | |
| Overall | A | A | A | A | C | C | C | C | C | C |
| evaluation | | | | | | | | | | |

Example 1: Very delicious cream with no problem in in-mouth meltability and thermostability at 25° C.
Example 2: Very delicious cream with no problem in in-mouth meltability and thermostability at 25° C. Example 3: Very delicious cream with no problem in in-mouth meltability and thermostability at 25° C.
Example 4: Very delicious cream with no problem in in-mouth meltability and thermostability at 25° C.
Comparative example 1: Cream had a higher specific gravity underwent separation
Comparative example 2: Cream had a higher specific gravity underwent separation
Comparative example 3: Cream had a bad in-mouth meltability with a higher specific gravity but no problem in 25° C. thermostability
Comparative example 4: Cream underwent oil-off at 25° C. and had somewhat bad in-mouth meltability with a higher specific gravity
Comparative example 5: Cream had bad in-mouth meltability with bad 25° C. thermostability and a higher specific gravity
Comparative example 6: Cream had bad in-mouth meltability with bad 25° C. thermostability and a higher specific gravity

From Tables 1 and 2, it is clearly understood that a foamable water-in-oil type emulsion composition satisfying the range requirements specified according to the present invention in terms of (a) solid fat content of fats and oils at 25° C., (b) content in fats and oils of unsaturated diglycerides having a carbon number ranging from 16 to 18 and (c) ratio of fats and oils versus liquid sugar can have a good in-mouth meltability and thermostability with lower specific gravity and thus can be used as an excellent buttercream.

### Preferred Examples 3 Through 8 and Comparative Examples 6 Through 10

(Preparation Of Fats and Oils and Syrup Used for the Preferred and Comparative Examples)

For preparation, fats and oils melted at 60° C. were cooled down to 15° C. in a chiller (emulsifying kneader made by Tama Seiki Kogyo Co., Ltd., Tokyo) and then maintained at 20° C. (for tempering) for 1 day followed by storage in a refrigerator (5° C.).

Also, syrup was melted at 70° C. and subjected to indirect sterilization (110° C. for 15 sec. on a sterilizer manufactured by Iwai Machinery Co., Ltd., Tokyo). Then, after cooling down to 30° C., the syrup was stored in a refrigerator (at 5° C.).

Each 100 parts by weight of the formulations A, B, C, D or E shown in Table 3 was whipped and then mixed under agitation with each 200 parts by weight of the formulations a, b, c, d or e shown in Table 4 in several fractions in accordance with specific combinations shown in Table 5 below to obtain each example of foamable water-in-oil type emulsion composition shown there.

### Preferred Examples 9 Through 12 and Comparative Example 11

(Preparation of Fats and Oils and Syrup Used for the Preferred and Comparative Examples)

For preparation, fats and oils melted at 60° C. were cooled down to 15° C. in a chiller (emulsifying kneader made by Tama Seiki Kogyo Co., Ltd., Tokyo) and then maintained at 20° C. (for tempering) for 1 day followed by storage in a refrigerator (5° C.).

Also, syrup was melted at 70° C. and subjected to indirect sterilization (110° C. for 15 sec. on a sterilizer manufactured by Iwai Machinery Co., Ltd., Tokyo). Then, after cooling down to 30° C., the syrup was stored in a refrigerator (at 5° C.).

Each 100 parts by weight of the formulations A, B or D shown in Table 3 was whipped and then mixed under agitation with each 80 parts by weight of the formulations a or d shown in Table 4 in several fractions to obtain an example of foamable water-in-oil type emulsion composition. For this, specific combinations of syrup with fats and oils are shown in Table 7 below.

Here, the solid fat content (SFC) at 25° C. of the fats and oils used was determined in the same manner as described previously.

TABLE 3

| Fats and oils | Formulation A | Formulation B | Formulation C | Formulation D | Formulation E |
|---|---|---|---|---|---|
| Hydrogenated | 20.0 | 20.0 | 15.0 | 20.0 | 20.0 |
| rapeseed oil | | | | | |
| (IV80) (wt %) | | | | | |
| Hydrogenated | 10.0 | 10.0 | 15.0 | 20.0 | 30.0 |
| palm oil (IV40)(wt %) | | | | | |
| Refined rapeseed | 70.0 | 0.0 | 70.0 | 60.0 | 50.0 |
| oil (wt %) | | | | | |
| Unsaturated | 0.0 | 70.0 | 0.0 | 0.0 | 0.0 |
| diglyceride*¹ (wt %) | | | | | |
| Triglyceride (%)*² | 98.7 | 38.9 | 98.3 | 97.9 | 97.2 |
| Diglyceride*² | 1.3 | 60.4 | 1.6 | 2.0 | 2.7 |
| Monoglyceride*² | 0.0 | 0.7 | 0.1 | 0.1 | 0.1 |
| 25° C. SFC (%) | 7.1 | 7.0 | 4.0 | 12.5 | 18.1 |
| Unsaturated | 86.18 | 87.66 | 84.20 | 81.63 | 77.08 |
| Fatty acid content | | | | | |
| (wt %) | | | | | |
| MP (° C.) | 29 | 28 | 25 | 32 | 35 |
| Specific gravity | 0.35 | 0.22 | 0.95 | 0.42 | 0.48 |
| after whipping | | | | | |
| *¹Using an immobilized 1,3-positions selective lipase (trade name: “Lipozyme 3A), 860 g of a rapeseed oil-derived fatty acid was allowed to react with 140 g of glycerin at 40° C. for 10 hours. After filtering out the lipase agent, | | | | | |
| # the reaction product was subjected to molecular distillation and refined in the usual manner to obtain a liquid unsaturated diglyceride. This resultant composition contained 1.0 wt % monoglyceride, 85.0 wt % diglyceride and 14.0 wt % triglyceride. | | | | | |

*²given in weight percent of fats and oils(A)

TABLE 4

| Syrup | Formulation a | Formulation b | Formulation c | FormulaTion d | Formulation e | Formulation f |
|---|---|---|---|---|---|---|
| High maltose | 80.0 | 80.0 | 80.0 | 80.0 | 80.0 | 80.0 |
| syrup | | | | | | |
| MC-45 (Brix70) | | | | | | |
| Gluten | 5.0 | 4.0 | 3.0 | 2.0 | | 2.0 |
| Casein Na | | | | | 2.0 | |
| Gelatin | 1.0 | 0.7 | 0.5 | 0.3 | 0.2 | |
| Carageenan | | | | | | |
| Sucrose ester | | | | | | 0.2 |
| S1670 (HLB16) | | | | | | |
| Water | 14.0 | 15.3 | 16.5 | 17.7 | 17.8 | 17.8 |
| Liquid state after | B | B+ | A | A | A | A |
| preparation | | | | | | |
| (5° C.) | | | | | | |

TABLE 5

| | Formulation a | Formulation b | Formulation c | Formulation d | Formulation e | Formulation f |
|---|---|---|---|---|---|---|
| Formulation A | Example 3 | Example 4 | Example 5 | Example 6 | Comparative | Comparative |
| | | | | | example 9 | example 10 |
| Formulation B | Preferred | | | Example 8 | | |
| | example 7 | | | | | |
| Formulation C | | | | Comparative | | |
| | | | | example 6 | | |
| Formulation D | | | | Comparative | | |
| | | | | example 7 | | |
| Formulation E | | | | Comparative | | |
| | | | | example 8 | | |

For each resultant emulsion composition, the specific gravity was measured using a specific gravity cup.
Specific gravity (g/ml)=cream weight (g)/volume of specific gravity cup (ml)

The resultant compositions were subjected to a sensory test by 20 expert panelists for evaluation of in-mouth meltability and sweetness.

Further, after maintaining a filter paper coated with a predetermined quantity of each cream at 25° C. for 2 days, the cream was removed and the quantity of the residual cream impregnated in the filter paper was measured as the oil-off quantity.

For evaluation of 25° C. thermostability, a composition having an oil-off smaller than 15 wt % was rated as good (A), with 15 to 20 wt % oil-off as average (B) and 20 wt % or larger oil-off as bad (C).

Further, for overall evaluation, those samples having a specific gravity ranging from 0.15 to 0.70 and rated as good all in in-mouth meltability, cream lightness, sweetness and thermostability were evaluated as good (A), while samples rated as bad in at least one of these test items were evaluated as bad (C).

These evaluation results are shown in Table 6 and 7 below.

TABLE 6

| | | | | | | | | | | | Compar- |
|---|---|---|---|---|---|---|---|---|---|---|---|
| | | | | | | | | Compar- | Compar- | Compar- | ative |
| | Preferred | Preferred | Preferred | Preferred | Preferred | Preferred | Comparative | ative | ative | ative | example |
| | example 3 | example 4 | example 5 | example 6 | example 7 | example 8 | example 6 | example 7 | example 8 | example 9 | 10 |
| Specific gravity | 0.63 | 0.55 | 0.50 | 0.50 | 0.40 | 0.38 | 1.20 | 0.65 | 0.75 | 0.80 | 0.82 |
| In-mouth | B+ | B+ | A | A | A+ | A+ | C | B | C | C | C |
| meltability | | | | | | | | | | | |
| Cream | B | B+ | A | A | A | A | C | B | C | C | C |
| lightness | | | | | | | | | | | |
| Cream | B+ | A | A | A | A | A | C | B+ | B+ | B | B |
| sweetness | | | | | | | | | | | |
| 25° C. | A | A | A | A | A | A | C | A | A | C | C |
| thermostability | | | | | | | | | | | |
| Overall | B+ | A | A | A | A | A | C | B | C | C | C |
| evaluation | | | | | | | | | | | |

TABLE 7

| | Preferred example 9 | Preferred example 10 | Preferred example 11 | Preferred example 12 | Comparative example 11 |
|---|---|---|---|---|---|
| | Formulations a + A | Formulations d + A | Formulations a + B | Formulations d + B | Formulations d + D |
| Specific gravity | 0.58 | 0.48 | 0.27 | 0.23 | 0.65 |
| In-mouth | B+ | A | A+ | A+ | B |
| meltability | | | | | |
| Cream | A | A | A+ | A+ | B |
| lightness | | | | | |
| Cream | B+ | A | A+ | A+ | B |
| sweetness | | | | | |
| 25° C. | A | A | A | A | A |
| thermostability | | | | | |
| Overall | A | A | A | A | B |
| evaluation | | | | | |

Example 3: Cream was somewhat heavy. The cream lightness was insufficient with somewhat bad in-mouth meltability and sweetness.
Example 4: Cream was somewhat bad in in-mouth meltability and sweetness.
Example 5: Very delicious cream with no problem in in-mouth meltability, cream lightness, sweetness and thermostability at 25° C.
Example 6: Very delicious cream with no problem in in-mouth meltability, cream lightness, sweetness and thermostability at 25° C.
Example 7: Very delicious cream with no problem in in-mouth meltability, cream lightness, sweetness and thermostability at 25° C.
Example 8: Very delicious cream with no problem in in-mouth meltability, cream lightness, sweetness and thermostability at 25° C.
Example 9: Cream was somewhat heavy. Cream was somewhat bad in in-mouth meltability and sweetness.
Example 10: Very delicious cream with no problem in in-mouth meltability, cream lightness, sweetness and thermostability at 25° C.
Example 11: Very delicious cream with no problem in in-mouth meltability, cream lightness, sweetness and thermostability at 25° C.
Example 12: Very delicious cream with no problem in in-mouth meltability, cream lightness, sweetness and thermostability at 25° C.
Comparative example 6: The fats and oils did not foam and when mixed with syrup, the mixture had a higher specific gravity and underwent separation.
Comparative example 7: The fats and oils had insufficient foamability and when mixed with syrup, no sufficient in-mouth meltability and cream lightness were observed.
Comparative example 8: The fats and oils had insufficient foamability and inferior mixing aptitude with syrup, resulting in bad in-mouth meltability and cream lightness.
Comparative example 9: The syrup underwent separation with inferior mixing aptitude.
Comparative example 10: The syrup underwent separation with inferior mixing aptitude.
Comparative example 11: The fats and oils had insufficient foamability and when mixed with syrup, no sufficient in-mouth meltability, cream lightness and sweetness were observed.

From Tables 3 through 7, it is clearly understood that a foamable water-in-oil type emulsion composition satisfying the range requirements specified according to the present invention in the contents of (A) fats and oils, (B) saccharide, (C) gluten and (D) gelatin can have a good in-mouth meltability, cream lightness and thermostability with lower specific gravity and thus can be used as an excellent buttercream.

### Preferred Examples 13 Through 16 and Comparative Examples 12-14

Each 200 parts by weight of the syrup formulations g, h, i or j shown in Table 8 was whipped by Hobart Mixer (manufactured by Hobart Corporation, OH, U.S.A.) along with a wire whisk and then thereto was added under agitation each 100 parts by weight of the formulations F, G, H, I or J shown in Table 9 to produce a foamable water-in-oil type emulsion composition.

Here, the solid fat content (SFC) at 25° C. of the fats and oils used was determined in the same manner as in preferred example 1.

TABLE 8

(wt %)

| Syrup | Formulation g | Formulation h | Formulation i | Formulation j |
|---|---|---|---|---|
| High-maltose | 90.0 | 90.0 | 90.0 | 90.0 |
| MC-45(Brix70) | | | | |
| Gluten | 2.0 | | 2.0 | 2.0 |
| Gelatin | 0.2 | 0.2 | | |
| Casein Na | | | | |
| Sucrose ester | | | | 0.2 |
| S-1670 | | | | |
| Corn starch | 2.0 | 2.0 | 2.0 | 2.0 |
| (modified starch) | | | | |
| Water | 5.8 | 7.8 | 6.0 | 5.8 |
| Liquid state after | Uniform | Uniform | Separated | Uniform |
| Preparation (5° C.) | | | | |
| Specific gravity | 0.18 | 0.90 | | 0.25 |
| after whipping | | | | |

Formulation h: a higher specific gravity
Formulation i: liquid separated (unstable)
The syrups of the formulations g and j were whipped, respectively, and then mixed with the respective fats and oils formulations shown in Table 9.

TABLE 9
(wt %)

| Fats and oils | Formulation F | Formulation G | Formulation H | Formulation I | Formulation J |
|---|---|---|---|---|---|
| Hydrogenated | 19.0 | 19.0 | 19.0 | 14.3 | 14.3 |
| rapeseed oil | | | | | |
| (IV80) | | | | | |
| Hydrogenated | 9.5 | 9.5 | 28.5 | 14.3 | 14.3 |
| palm oil (IV40) | | | | | |
| Refined rapeseed | 66.5 | | 47.5 | 66.4 | |
| oil | | | | | |
| Unsaturated | | 66.5 | | | 66.4 |
| diglyceride*¹ | | | | | |
| Sucrose ester | 0.1 | 0.1 | 0.1 | 0.1 | 0.1 |
| S1170*² | | | | | |
| Water | 4.9 | 4.9 | 4.9 | 4.9 | 4.9 |
| 25° C. SFC (%) | 7.1 | 7.0 | 18.1 | 4.1 | 4.0 |
| MP (° C.) | 29 | 28 | 32 | 25 | 24 |
| 25° C. fluidity | Observed | Observed | None | Observed | Existed |
| Specific gravity | — | — | 0.37 | 0.40 | 0.24 |
| after whipping | | | | | |
| *¹Using an immobilized 1,3-positions selective lipase (trade name: “Lipozyme 3A), 860 g of a rapeseed oil-derived fatty acid was allowed to react with 140 g of glycerin at 40° C. for 10 hours. After filtering out the lipase agent, the reaction product was subjected to molecular distillation and refined in the usual manner to obtain a liquid unsaturated diglyceride. | | | | | |
| # This resultant composition contained 1.0 wt % monoglyceride, 85.0 wt % diglyceride and 14.0 wt % triglyceride. | | | | | |

*²Produced by Mitsubishi-Kagaku Foods Corporation, Tokyo.

For each whipped composition and resultant emulsion composition, the specific gravity was measured using a specific gravity cup.
Specific gravity (g/ml)=cream weight (g)/volume of specific gravity cup (ml)

The resultant compositions were subjected to a sensory test by 20 expert panelists for evaluation of in-mouth meltability.

Also, the resultant compositions were subjected to a sensory test by 20 expert panelists for evaluation of cream lightness and sweetness.

Further, after maintaining a filter paper coated with a predetermined quantity of each cream at 25° C. for 2 days, the cream was removed and the quantity of the residual cream impregnated in the filter paper was measured as the oil-off quantity.

For evaluation of 25° C. thermostability, a composition having an oil-off smaller than 15 wt % was rated as good (A), with 15 to 20 wt % oil-off as average (B) and 20 wt % or larger oil-off as bad (C).

Further, for overall evaluation, those samples having a specific gravity ranging from 0.20 to 0.60 and rated as good all in in-mouth meltability, cream lightness, sweetness and thermostability were evaluated as good (A), while samples rated as bad in at least one of these test items were evaluated as bad (C).

The evaluation result is shown in Table 10 below.

TABLE 10

| | Preferred | | | |
|---|---|---|---|---|
| | example 13*¹ | Preferred | Preferred | Preferred |
| | (Formulation g + | example 14*¹ | example 15*³ | example 16*³ |
| | formulation | (Formulation g + formulation | (Formulation g + formulation | (Formulation g + formulation |
| | F) | G) | D) | I) |
| Specific gravity | 0.45 | 0.38 | 0.35 | 0.24 |
| In-mouth | A | A+ | A | A+ |
| meltability | | | | |
| Cream lightness | A | A+ | A | A+ |
| Cream sweetness | A | A | A | A |
| 25° C. | A | A | A | A |
| thermostability | | | | |
| Overall evaluation | A | A | A | A+ |

| | Comparative | Comparative | Comparative |
|---|---|---|---|
| | example 12^{*1} | example 13^{*1} | example 14^{*3} |
| | (Formulation g + formulation | (Formulation g + formulation | (Formulation g + formulation |
| | H) | F) | H) |
| Specific gravity | 0.99 | 0.68 | 0.89 |
| In-mouth | C | A | C |
| meltability | | | |
| Cream lightness | C | B | C |
| Cream sweetness | C | C | C |
| 25° C. | C | C | A |
| thermostability | | | |
| Overall evaluation | C^{*2} | C | C |

*¹After whipping the aqueous phase, the oil phase was mixed therewith.
*²Phase was inverted to oil-in-water type.
*³After whipping the oil phase and the aqueous phase, the both phases were mixed together.

Example 13: In-mouth meltability, cream lightness and sweetness were good with excellent thermostable shape retention at 25° C.
Preferred example 14: In-mouth meltability, cream lightness and sweetness were good with excellent thermostable shape retention at 25° C.
Preferred example 15: In-mouth meltability, cream lightness and sweetness were good with excellent thermostable shape retention at 25° C.
Preferred example 16: In-mouth meltability, cream lightness and sweetness were good with excellent thermostable shape retention at 25° C.
Comparative example 12: When mixing with syrup, phase inversion into O/W (oil-in-water) state occurred with accompanying separation (loss of commercially acceptable state).
Comparative example 13: Good in-mouth meltability. Cream lightness was observed but not sufficient and the cream was unduly sweet and underwent separation at 25° C.
Comparative example 14: Despite excellent 25° C. thermostable shape retention, the in-mouth meltability and cream lightness were not sufficient and the cream was unduly sweet.

From Tables 8 through 10 above, the foamable water-in-oil type emulsion composition produced by the method of the present invention has a lower specific gravity and is improved in in-mouth meltability, cream lightness, sweetness and thermostability, so that the present emulsion composition can be used as an excellent buttercream. In this connection, the comparative example 12 underwent phase inversion to O/W (oil-in-water) state.

Meanwhile, when preparing the formulations used in the preferred examples 13 and 14, the oil and fat parts are first whipped and then the syrup was added under agitation thereto to obtain the respective foamable water-in-oil type emulsion compositions. The resultant compositions did not provide light eating texture with their specific gravities ranging from 0.6 to 0.7.

What is claimed is:

1. A foamable water-in-oil type emulsion composition comprising diglyceride-containing fats and oils and a liquid sugar, wherein (a) said fats and oils have a solid fat content ranging from 0.5 to 5% thereof; (b) said fats and oils contain 40 wt % or more of an unsaturated diglyceride having a carbon number ranging from 16 to 18; and (c) the weight ratio of said fats and oils vs. said liquid sugar ranges from 1:0.5 to 1:4.

2. The foamable water-in-oil type emulsion composition as set forth in claim 1 above, wherein said emulsion composition has a specific gravity ranging from 0.30 to 0.70.

3. The foamable water-in-oil type emulsion composition as set forth in claim 1 or 2 above, wherein said liquid sugar has a sugar content ranging from 40 to 80 wt %.

4. The foamable water-in-oil type emulsion composition as set forth in any one of the preceding claims 1 through 3, wherein the ratio of said fats and oils vs. said liquid sugar ranges from 1:1 to 1:4.

5. A foamable water-in-oil type emulsion composition comprising the following ingredients (A) through (D):
(A) fats and oils having a solid fat content (SFC) ranging from 5 to 10% and an unsaturated fatty acid content ranging from 40 to 90 wt %
10 to 70 wt %;
(B) saccharides 10 to 60 wt %;
(C) gluten 0.4 to 5.0 wt %; and
(D) gelatin 0.05 to 1.0 wt %.

6. The foamable water-in-oil type emulsion composition as set for the in claim 5 above, wherein said emulsion composition has a specific gravity ranging from 0:15 to 0.70.

7. The foamable water-in-oil type emulsion composition as set forth in claim 5 or 6 above, wherein the content of said saccharides (B) ranges 40 to 75 wt % of an aqueous phase used.

8. The foamable water-in-oil type emulsion composition as set forth in any one of the preceding claims 5 through 7, wherein the ratio of said gluten (C) vs. said gelatin (D) ranges from 1:1 to 50:1.

9. The foamable water-in-oil type emulsion composition as set forth in any one of the preceding claims 5 through 8, wherein the ratio of said fats and oils vs. said aqueous phase ranges from 1:0.3 to 1:4.

10. A method of producing a foamable water-in-oil type emulsion composition, comprising whipping an aqueous phase containing saccharide and protein and then adding thereto fluid fats and oils having an 15% or lower solid fat content (SFC) at 25° C.

11. The method of producing a foamable water-in-oil type emulsion composition as set forth in claim 10 above, wherein the resultant foamable water-in-oil type emulsion composition has a specific gravity ranging from 0.20 to 0.60.

12. The method of producing a foamable water-in-oil type emulsion composition as set forth in claim 10 or 11 above, wherein said protein comprises gluten and gelatin.

13. The method of producing a foamable water-in-oil type emulsion composition as set forth in claim 12 above, wherein the total content of said gluten and said gelatin ranges from 0.5 to 6.0 wt % of an aqueous phase used and wherein the weight ratio of said gluten vs. said gelatin ranges from 1:1 to 50:1.

14. The method of producing a foamable water-in-oil type emulsion composition as set forth in any one of the preceding claims 10 through 13 above, wherein said fats and oils comprises fluid fats and oils having a solid fat content ranging from 5 to 15% at 25° C.
